(19) United States
(12) Patent Application Publication
(10) Pub. No.: US 2024/0011658 A1
(43) Pub. Date: Jan. 11, 2024

(54) MACHINE LEARNING DEVICE, VENTILATION CONTROL DEVICE, AND VENTILATION CONTROL METHOD

(71) Applicant: DAIKIN INDUSTRIES, LTD., Osaka (JP)

(72) Inventors: Shota TSURUZONO, Osaka (JP); Tomoyoshi ASHIKAGA, Osaka (JP); Takahiro OHGA, Osaka (JP)

(21) Appl. No.: 18/372,484

(22) Filed: Sep. 25, 2023

Related U.S. Application Data
(63) Continuation of application No. PCT/JP2022/015676, filed on Mar. 29, 2022.

(30) Foreign Application Priority Data
Mar. 31, 2021 (JP) 2021-061762

(51) Int. Cl. F24F 11/63

(52) U.S. Cl. CPC F24F 11/63; F24F 2110/70

(57) ABSTRACT

A machine learning device includes a first acquisition unit, a second acquisition unit, and a learning unit. The first acquisition unit acquires environmental information on a target space. The second acquisition unit acquires number-of-people information indicating a number of people in the target space. The learning unit learns the environmental information acquired by the first acquisition unit and the number-of-people information acquired by the second acquisition unit in association with each other. The environmental information includes an actual carbon dioxide concentration in the target space.

### CROSS-REFERENCE TO RELATED APPLICATIONS

This is a continuation of International Application No. PCT/JP2022/015676 filed on Mar. 29, 2022, which claims priority to Japanese Patent Application No. 2021-061762, filed on Mar. 31, 2021. The entire disclosures of these applications are incorporated by reference herein.

### BACKGROUND

### Technical Field

The present disclosure relates to a machine learning device, a ventilation control device, and a ventilation control method.

### Background Art

In the related art, the amount of carbon dioxide in a room is measured by a carbon dioxide sensor, and when the amount of carbon dioxide as a result of the measurement exceeds a predetermined value, the amount of ventilation air is controlled (Japanese Unexamined Patent Application Publication No. 2010-96382).

### SUMMARY

A machine learning device according to a first aspect includes a first acquisition unit, a second acquisition unit, and a learning unit. The first acquisition unit acquires environmental information on a target space. The second acquisition unit acquires number-of-people information indicating the number of people in the target space. The learning unit learns the environmental information acquired by the first acquisition unit and the number-of-people information acquired by the second acquisition unit in association with each other. The environmental information includes an actual carbon dioxide concentration in the target space.

### BRIEF DESCRIPTION OF THE DRAWINGS

FIG. 1 is a functional block diagram of a machine learning device.

FIG. 2 is a functional block diagram of a ventilation control system.

FIG. 3 is a schematic view of a model of neurons in a neural network.

FIG. 4 is a diagram illustrating an example of learning data.

FIG. 5 is a diagram illustrating an example of changes in an actual value and a prediction value of a carbon dioxide concentration over time.

FIG. 6 is a flowchart for the ventilation control system.

FIG. 7 is a functional block diagram of a machine learning device.

FIG. 8 is a flowchart of a ventilation control system.

FIG. 9A is a diagram illustrating an example of a change in a prediction value of a carbon dioxide concentration over time.

FIG. 9B is a diagram illustrating an example of a change in the number of people in a room over time.

FIG. 9C is a diagram illustrating an example of a change in time required for reaching a threshold over time.

FIG. 10 is a functional block diagram of a machine learning device.

FIG. 11 is a functional block diagram of a ventilation control system.

FIG. 12 is a flowchart of the ventilation control system.

### DETAILED DESCRIPTION OF EMBODIMENT(S)

### First Embodiment

### (1) Overall Configuration of Ventilation Control System

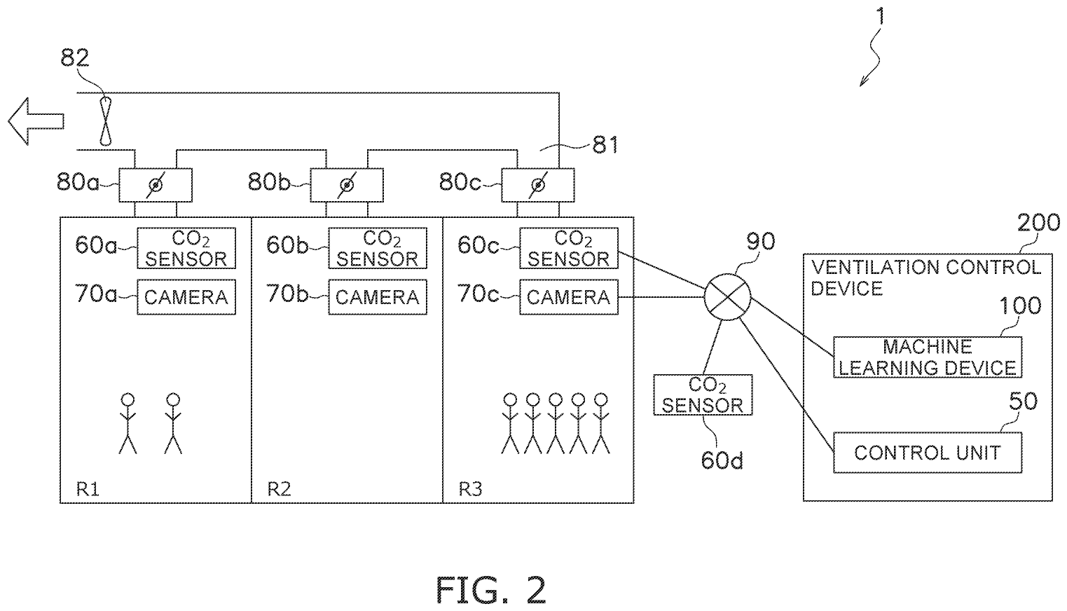

A ventilation control system 1 of the present embodiment is a system provided to perform ventilation control for rooms R1 to R3 that are target spaces. As illustrated in FIG. 2, the ventilation control system 1 mainly includes dampers 80a to 80c, a duct pipe 81, a fan 82, carbon-dioxide sensors 60a to 60d, cameras 70a to 70c, and a ventilation control device 200.

The ventilation control device 200 is implemented by a computer. The ventilation control device 200 includes a machine learning device 100 and a control unit 50.

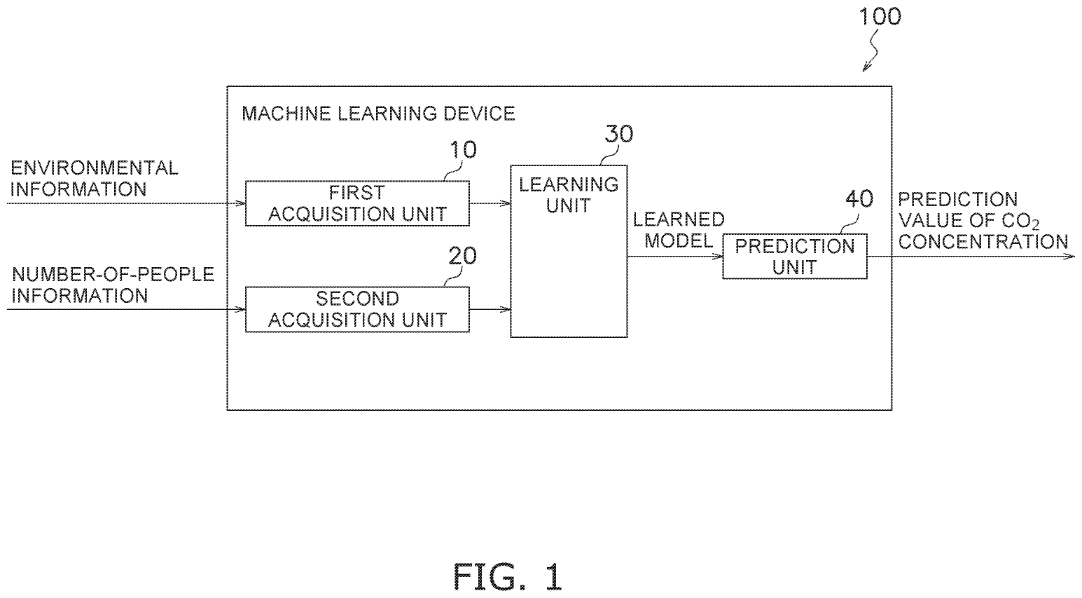

As illustrated in FIG. 1, the machine learning device 100 includes a first acquisition unit 10, a second acquisition unit 20, a learning unit 30, and a prediction unit 40. The first acquisition unit 10 acquires environmental information on the target spaces R1 to R3. The second acquisition unit 20 acquires number-of-people information indicating the numbers of people in the target spaces R1 to R3. The learning unit 30 learns the environmental information and the number-of-people information in association with each other. The prediction unit 40 predicts carbon dioxide concentrations in the target spaces R1 to R3 after a certain period of time as prediction values from the environmental information and the number-of-people information, based on a result of the learning by the learning unit 30.

The ventilation control device 200 controls the dampers 80a to 80c, based on the prediction values of the carbon dioxide concentrations in the rooms R1 to R3 after the certain period of time, the prediction values being outputs from the prediction unit 40 of the machine learning device 100.

The machine learning device 100 acquires actual carbon dioxide concentrations in the rooms R1 to R3 from the carbon dioxide sensors 60a to 60c installed in the rooms R1 to R3, over a network 90. Furthermore, the machine learning device 100 acquires an external carbon dioxide concentration from the carbon dioxide sensor 60d externally installed, over the network 90. Furthermore, the machine learning device 100 acquires the number-of-people information on the rooms R1 to R3 from the cameras 70a to 70c installed in the rooms R1 to R3, over the network 90.

### (2) Detailed Configuration

### (2-1) Machine Learning Device

### (2-1-1) First Acquisition Unit

The first acquisition unit 10 acquires the environmental information on the rooms R1 to R3 which are the target spaces. In the present embodiment, the environmental information includes the actual carbon dioxide concentrations in the target spaces R1 to R3. The environmental information on the target spaces R1 to R3 further includes a carbon dioxide concentration of the outside air and ventilation volumes of the target spaces R1 to R2 or volumes of the target spaces R1 to R3. The ventilation volumes of the target spaces R1 to R3 are ventilation volumes of the dampers 80a to 80c which are ventilating devices.

In the present embodiment, the first acquisition unit 10 acquires the actual carbon dioxide concentrations in the target spaces R1 to R3 by using the carbon dioxide concentration sensors 60a to 60c. The first acquisition unit 10 acquires the carbon dioxide concentration of the outside air by using the external carbon dioxide sensor 60d. The first acquisition unit 10 acquires the ventilation volumes of the dampers 80a to 80c, which are the ventilating devices, from a catalog or the like of the ventilating devices. The first acquisition unit 10 acquires the volumes of the target spaces R1 to R3 using a drawing.

### (2-1-2) Second Acquisition Unit

The second acquisition unit 20 acquires the number-of-people information indicating the numbers of people in the rooms R1 to R3 which are the target spaces. In the present embodiment, the second acquisition unit 20 acquires the number-of-people information indicating the numbers of people in the rooms R1 to R3 by using the cameras 70a to 70c installed in the rooms R1 to R3. As illustrated in FIG. 2, the number of people in the room R1 is two. The number of people in the room R2 is zero. The number of people in the room R3 is five.

### (2-1-3) Learning Unit

The learning unit 30 learns the environmental information acquired by the first acquisition unit 10 and the number-of-people information acquired by the second acquisition unit 20 in association with each other. The learning unit 30 performs machine learning by using, as information, the environmental information and the number-of-people information that are different among the target spaces, and creates a carbon dioxide concentration estimation model expressed by Formula 1 below.

$$\frac{Δ C}{Δ t} = \frac{( {C}_{0} - C ) * Qm}{V} * a + \frac{{M}_{h} * n}{V} * b \qquad Formula 1$$

where
C: carbon dioxide concentration in room (ppm)
Cₒ: carbon dioxide concentration of outside air (ppm)
Qₘ: ventilation volume of ventilating device (m³/h)
V: room volume (m³)
Mₕ: general carbon dioxide emission of people (m³/h·persons)
N: number of people (persons)

FIG. 3 is a schematic view of a model of neurons in a neural network. As illustrated in FIG. 3, the neurons output an output y in response to a plurality of inputs (inputs x₁ and x₂ in FIG. 3). Each input (inputs x₁ and x₂ in FIG. 3) is multiplied by a corresponding weight. A weight a corresponds to the input x₁. A weight b corresponds to the input x₂.

In the present embodiment, the input x₁ represents (Cₒ-C)*Qₘ/V which is a change in the carbon dioxide concentration caused by the ventilating device. The input x₂ indicates Mₕ*n/V which is a change in the carbon dioxide concentration caused by people. The output y indicates ΔC/Δt (slope).

In the present embodiment, the weights (coefficients) a and b are learned through comparison between ΔC/Δt (slope) and actual values of the carbon dioxide concentration, using the steepest descent method. The values of the weights a and b are determined for each of the target spaces R1 to R3.

(2-1-4) Prediction unit

The prediction unit 40 predicts the carbon dioxide concentrations in the target spaces R1 to R3 after the certain period of time as prediction values from the environmental information and the number-of-people information on the target spaces R1 to R3, based on a result of the learning by the learning unit 30.

The prediction unit 40 predicts the carbon dioxide concentration in the target space R1 after the certain period of time as the prediction value using the carbon dioxide concentration estimation model (learned model) expressed by Formula 1 created through the learning by the learning unit 30 from the environmental information and the number-of-people information on the target space R1 as input information.

The prediction unit 40 predicts the carbon dioxide concentration in the target space R2 after the certain period of time as the prediction value using the carbon dioxide concentration estimation model expressed by Formula 1 created through the learning by the learning unit 30 from the environmental information and the number-of-people information on the target space R2 as input information.

The prediction unit 40 predicts the carbon dioxide concentration in the target space R3 after the certain period of time as the prediction value using the carbon dioxide concentration estimation model expressed by Formula 1 created through the learning by the learning unit 30 from the environmental information and the number-of-people information on the target space R3 as input information.

The prediction unit 40 may predict the carbon dioxide concentrations after the certain period of time, that is, after an elapse of time Δt, using ΔC/Δt in Formula 1.

### (2-2) Control Unit

The control unit 50 controls the dampers 80a to 80c installed in the target spaces R1 to R3, based on the prediction values of the carbon dioxide concentrations in the target spaces R1 to R3 after the certain period of time, the prediction values being outputs from the prediction unit 40 of the machine learning device 100.

The control unit 50 is implemented by a computer. The control unit 50 includes a control calculation device and a storage device (not illustrated). A processor such as a CPU or a GPU is usable for the control calculation device. The control calculation device reads a program stored in the storage device and executes predetermined image processing and calculation processing based on the program. Furthermore, based on the program, the control calculation device may write a calculation result to the storage device and read information stored in the storage device. The storage device is usable for a database.

### (3) Learning Processing

The learning unit 30 learns the environmental information, the number-of-people information, and the change in the carbon dioxide concentration in a minute time, as a learning data set. In the present embodiment, the environmental information includes the actual carbon dioxide concentrations in the rooms, the carbon dioxide concentration of the outside air, and the ventilation volumes of the ventilating devices. The number-of-people information is information indicating the number of people in a target space.

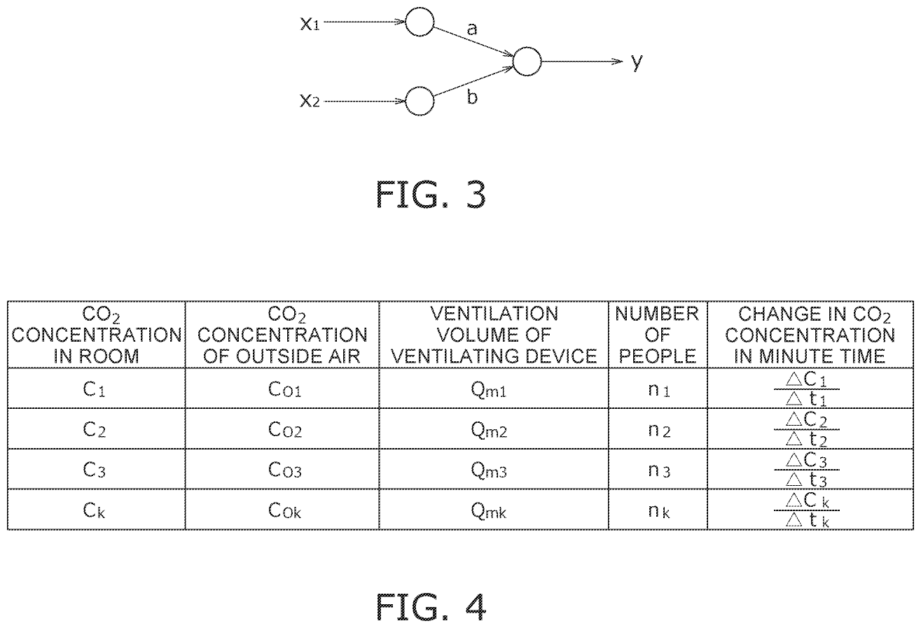

FIG. 4 illustrates an example of the learning data for the room R1. The room R1 is assumed to have a room volume V1 and has the damper 80a as the ventilating device. As illustrated in FIG. 4, learning is performed using a learning data set for outputting a carbon dioxide concentration ΔC₁/Δt₁ in a minute time, from inputs including a carbon dioxide concentration C₁ in the room, a carbon dioxide concentration Cₒ₁ of the outside air, a ventilation volume Qₘ₁ of the ventilating device, and the number n₁ of people in the room R1. Furthermore, learning is performed using a learning data set for outputting a carbon dioxide concentration ΔC₂/Δt₂ in a minute time, from inputs including a carbon dioxide concentration C₂ in the room, a carbon dioxide concentration Cₒ₂ of the outside air, a ventilation volume Qₘ₂ of the ventilating device, and the number n₂ of people in the room R1. Furthermore, learning is performed using a learning data set for outputting a carbon dioxide concentration ΔC₃/Δt₃ in a minute time, from inputs including a carbon dioxide concentration C₃ in the room, a carbon dioxide concentration Cₒ₃ of the outside air, a ventilation volume Qₘ₃ of the ventilating device, and the number n₃ of people in the room R1. Furthermore, learning is performed using a learning data set for outputting a carbon dioxide concentration ΔCₖ/Δtₖ in a minute time, from inputs including a carbon dioxide concentration Cₖ in the room, a carbon dioxide concentration Cₒₖ of the outside air, a ventilation volume Qₘₖ of the ventilating device, and the number nₖ of people in the room R1.

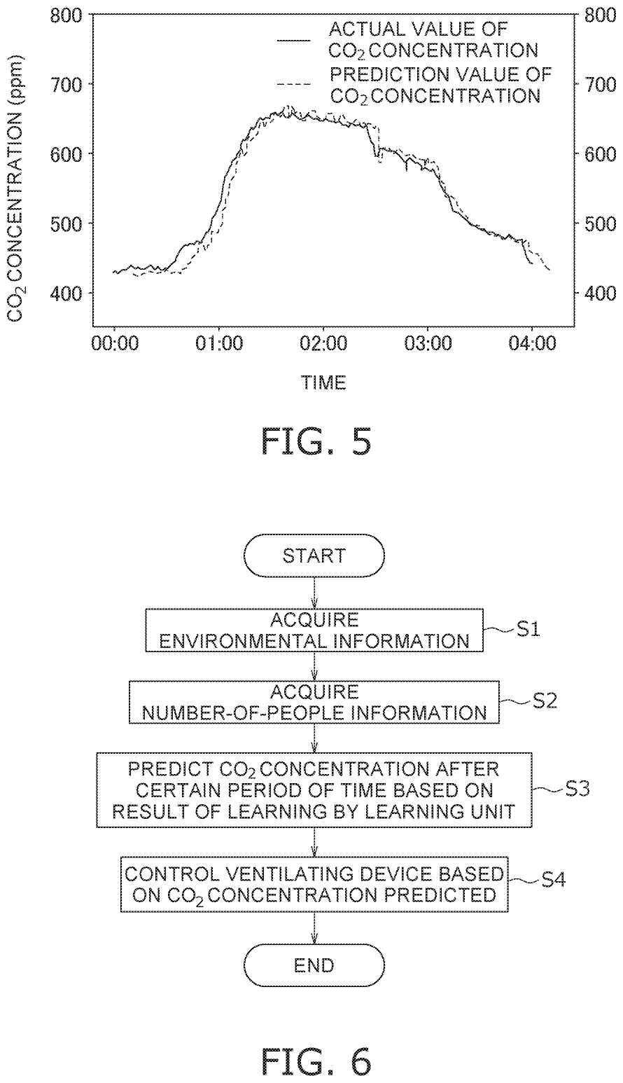

FIG. 5 illustrates an example of changes in the actual value and the prediction value of the carbon dioxide concentration in the target space R1 over time. A solid line indicates the actual value of the carbon dioxide concentration, and a dotted line indicates the prediction value of the carbon dioxide concentration. The prediction value is obtained by using the carbon dioxide concentration estimation model obtained by the learning using the learning data sets for the target space R1. The prediction value is obtained by predicting the carbon dioxide concentration after 10 minutes from a certain time point. When the carbon dioxide concentration estimation model obtained by the learning using the learning data sets for the target space R1 is used, a mean deviation and a standard deviation between the actual value and the prediction value of the carbon dioxide concentration in the target space R1 are respectively 9.3 ppm and 8.0 ppm.

On the other hand, when the carbon dioxide concentration estimation model obtained by the learning using learning data sets for another room is used for obtaining the prediction value of the carbon dioxide concentration in the target space R1, a mean deviation and a standard deviation of the carbon dioxide concentration in the target space R1 are respectively 12.2 ppm and 8.5 ppm, meaning that the accuracy of the prediction value of the carbon dioxide concentration decreases. Thus, it is preferable to create the carbon dioxide concentration estimation model from the environmental information and the number-of-people information that are data on the target space.

### (4) Overall Operation of Ventilation Control System

FIG. 6 is a flowchart for the ventilation control system 1.

First of all, in step S1, the environmental information on the target spaces R1 to R3 is acquired (step S1). The number-of-people information indicating the numbers of people in the target spaces R1 to R3 is acquired (step S2).

Next, the carbon dioxide concentrations in the target spaces R1 to R3 after a certain period of time are predicted based on a result of the learning by the learning unit 30 (step S3). In the present embodiment, the carbon dioxide concentrations in the target spaces R1 to R3 after 10 minutes are assumed to be predicted.

In step S3, the carbon dioxide concentration in the target space R1 after 10 minutes is predicted based on a result of the learning by the learning unit 30 using, as input information, the environmental information and the number-of-people information on the target space R1. Furthermore, the carbon dioxide concentration in the target space R2 after 10 minutes is predicted based on a result of the learning by the learning unit 30 using, as input information, the environmental information and the number-of-people information on the target space R2. Furthermore, the carbon dioxide concentration in the target space R3 after 10 minutes is predicted based on a result of the learning by the learning unit 30 using, as input information, the environmental information and the number-of-people information on the target space R3.

Next, the dampers 80a to 80c are controlled based on the carbon dioxide concentrations predicted in step S3 (step S4).

### (5) Features

(5-1)

The machine learning device 100 of the present embodiment includes the first acquisition unit 10, the second acquisition unit 20, and the learning unit 30. The first acquisition unit 10 acquires the environmental information on the target spaces R1 to R3. The second acquisition unit 20 acquires the number-of-people information indicating the numbers of people in the target spaces R1 to R3. The learning unit 30 learns the environmental information acquired by the first acquisition unit 10 and the number-of-people information acquired by the second acquisition unit 20 in association with each other. The environmental information includes the actual carbon dioxide concentrations in the target spaces R1 to R3.

When the ventilation control is performed by monitoring the carbon dioxide concentration in real time to control the carbon dioxide concentration in a target space, the time required for starting the ventilating device and for data communication vary among properties. Thus, the carbon dioxide concentration may rise due to a sudden increase in the number of people in the room, an increase in the amount of speech, or the like, before the ventilation volume set for the ventilating device is reached. Furthermore, it takes time for the carbon dioxide concentration to diffuse after a person enters a target space. Thus, detection of a rise in the carbon dioxide concentration may be delayed.

The machine learning device 100 may create carbon dioxide concentration estimation models that are specific to the target spaces R1 to R3 and are usable for appropriate ventilation control in the target spaces R1 to R3. Thus, with the machine learning device 100 of the present embodiment, characteristics of the changes in the carbon dioxide concentrations, which differ among the target spaces, are recognized, so that the carbon dioxide concentrations may be estimated with high accuracy.

(5-2)

The machine learning device 100 of the present embodiment further includes the prediction unit 40 that predicts the carbon dioxide concentrations in the target spaces R1 to R3 after a certain period of time as prediction values from the environmental information and the number-of-people information, based on a result of the learning by the learning unit 30.

The machine learning device 100 predicts the carbon dioxide concentrations after the certain period of time from the environmental information and the number-of-people information on the target spaces R1 to R3, based on a result of the learning by the learning unit 30. Thus, even when the environments or the numbers of people in the target spaces R1 to R3 change within the certain period of time, the carbon dioxide concentrations specific to the target spaces R1 to R3 may be estimated with high accuracy.

(5-3)

In the machine learning device 100 according to the present embodiment, the environmental information further includes the ventilation volumes of the target spaces R1 to R3 or the volumes of the target spaces.

In the machine learning device 100, with the environmental information further including the ventilation volumes of the target spaces R1 to R3 or the volumes of the target spaces R1 to R3, the carbon dioxide concentrations specific to the target spaces R1 to R3 may be estimated with high accuracy.

(5-4)

The ventilation control device 200 of the present embodiment includes the machine learning device 100 and the control unit 50. The control unit 50 controls the ventilating devices 80a to 80c installed in the target spaces R1 to R3, based on the prediction values of the carbon dioxide concentrations in the target spaces R1 to R3 after the certain period of time, the prediction values being outputs from the prediction unit 40 of the machine learning device 100.

The Ministry of Health, Labour and Welfare has announced that the carbon dioxide concentration in a room not higher than 1000 ppm is one indication that the room is not a poorly ventilated enclosed space. On the other hand, due to the impact of infections, people are becoming more aware of enclosed spaces, resulting in excessive ventilation in some cases to suppress infection risks. As a result, the amount of energy consumption has increased due to factors such as an increase in the outside air load.

Since the ventilation control device 200 controls the ventilating devices 80a to 80c, based on the prediction values of the carbon dioxide concentrations in the target spaces R1 to R3 after the certain period of time, the carbon dioxide concentrations in the target spaces R1 to R3 after the certain period of time are predicted in advance, so that appropriate ventilation control may be performed on the target spaces R1 to R3. In addition, in the ventilation control device 200, the prediction values of the carbon dioxide concentrations in the target spaces R1 to R3 after the certain period of time are used to perform ventilation-associated operation in a feed-forward manner, and thus safety may be improved. Thus, both safety and energy conservation are achievable by performing necessary and sufficient ventilation to maintain the carbon dioxide concentrations at a certain set value or lower.

(5-5)

A ventilation control method by the ventilation control device 200 of the present embodiment includes a prediction step and a control step. In the prediction step, the carbon dioxide concentrations in the target spaces R1 to R3 after a certain period of time are predicted as prediction values from the environmental information and the number-of-people information, based on a result of the learning by the learning unit 30 of the machine learning device 100. In the control step, the ventilating devices installed in the target spaces R1 to R3 are controlled based on the prediction values of the carbon dioxide concentrations in the target spaces R1 to R3 after the certain period of time, the prediction values being outputs in the prediction step.

In the ventilation control method by the ventilation control device 200, since the ventilating devices are controlled based on the prediction values of the carbon dioxide concentrations in the target spaces R1 to R3 after the certain period of time, the carbon dioxide concentrations in the target spaces R1 to R3 after the certain period of time are predicted in advance, so that appropriate ventilation control may be performed on the target spaces R1 to R3.

### (6) Modifications

### (6-1) Modification 1A

In the present embodiment, a case where the prediction unit 40 predicts the carbon dioxide concentrations in the target spaces R1 to R3 after a certain period of time as prediction values is described. The prediction unit 40 may alternatively predict the amount of change in the carbon dioxide concentrations in the target spaces as a prediction value.

With the prediction unit predicting the amount of change in the carbon dioxide concentrations from the environmental information and the number-of-people information on the target spaces R1 to R3, based on a result of the learning by the learning unit, even when the environments or the numbers of people in the target spaces R1 to R3 change, the amount of change in the carbon dioxide concentrations specific to the target spaces R1 to R3 may be estimated with high accuracy.

### (6-2) Modification 1B

In the present embodiment, a case where the prediction unit 40 predicts the carbon dioxide concentrations in the target spaces R1 to R3 after a certain period of time as prediction values is described. The prediction unit 40 may also predict the carbon dioxide concentrations in the target spaces R1 to R3 in a steady state.

Based on input information on the target space at a certain time point, the prediction unit 40 may calculate and predict a concentration (carbon dioxide concentration in the steady state) at which the carbon dioxide concentration is maximized in the input information. For example, a value C in Formula 1 when ΔC/Δt=0, obtained using the environmental information and the number-of-people information on the target space at a certain time point, serves as the prediction value of the carbon dioxide concentration in the target space in the steady state.

In this way, how much the carbon dioxide concentration will rise may be predicted in advance using the input information such as the number-of-people information.

### (6-3) Modification 1C

In the present embodiment, a case where the environmental information is the carbon dioxide concentration of the outside air and the ventilation volumes of the target spaces or the volumes of the target spaces is described, but this is not construed in a limiting sense. The environmental information may be opening or closing of a door or a window of the target space.

With the environmental information including the opening or closing of a door or a window of the target spaces R1 to R3, even when ventilation of the target spaces R1 to R3 is performed by the opening or closing of the door or the window, the carbon dioxide concentrations specific to the target spaces R1 to R3 may be predicted with high accuracy.

By using the carbon dioxide concentration estimation model for each of the target spaces R1 to R3, for example, the carbon dioxide concentration is predicted in a case where input information such as the ventilation volume or the opening or closing of the window changes, so that an action for setting the carbon dioxide concentration to be equal to or lower than a predetermined carbon dioxide concentration, such as opening the window, may be proposed.

In the present embodiment, a case where the first acquisition unit 10 acquires the carbon dioxide concentration of the outside air by using the external carbon dioxide sensor 60d is described, but this is not construed in a limiting sense. For example, when the carbon dioxide concentration of the outside air is not able to be acquired, a value of 420 ppm, which is the carbon dioxide concentration generally contained in the atmosphere, may be used as the value of the carbon dioxide concentration of the outside air.

### (6-4) Modification 1D

In the present embodiment, a case where the second acquisition unit 20 acquires the number-of-people information is described, but this is not construed in a limiting sense. For example, the second acquisition unit may further acquire biometric information on people in the target space.

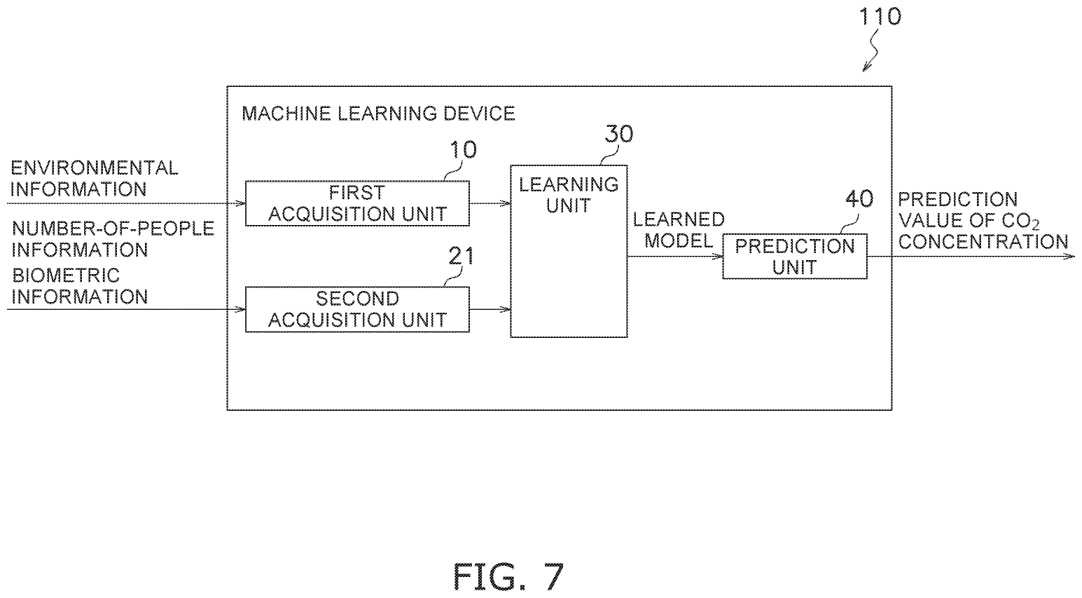

FIG. 7 is a functional block diagram of a machine learning device 110 of Modification 1D.

As illustrated in FIG. 7, the machine learning device 110 includes the first acquisition unit 10, a second acquisition unit 21, the learning unit 30, and the prediction unit 40. The first acquisition unit 10 acquires the environmental information on the target spaces R1 to R3. The second acquisition unit 21 acquires the number-of-people information indicating the numbers of people in the target spaces R1 to R3 and biometric information on the people in the target spaces R1 to R3. The learning unit 30 learns the environmental information, the number-of-people information, and the biometric information in association with each other. The prediction unit 40 predicts the carbon dioxide concentrations in the target spaces R1 to R3 after a certain period of time as prediction values from the environmental information, the number-of-people information, and the biometric information, based on a result of the learning by the learning unit 30.

The biometric information may include the conversation amount or the body temperature of the people in the target spaces R1 to R3. The biometric information may further include the gender, age, physique, or posture of the people in the target spaces R1 to R3.

The second acquisition unit 21 acquires the conversation amount of the people using, for example, a sound sensor. The second acquisition unit 21 acquires the body temperature of the people using a thermosensor. The second acquisition unit 21 acquires the gender, age, physique, or posture of people using a camera.

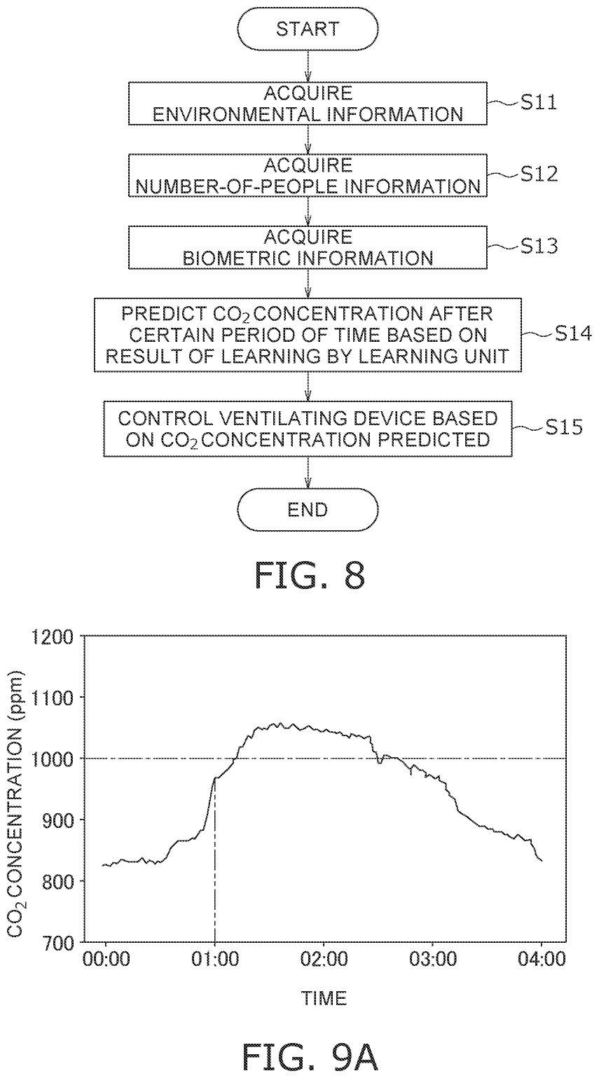

FIG. 8 is a flowchart of a ventilation control system of Modification 1D.

First of all, in step S1, the environmental information on the target spaces R1 to R3 is acquired (step S11). The number-of-people information indicating the numbers of people in the target spaces R1 to R3 is acquired (step S12). Next, the biometric information on the people in the target spaces R1 to R3 is acquired (step S13). Next, the carbon dioxide concentrations in the target spaces R1 to R3 after a certain period of time are predicted based on a result of the learning by the learning unit 30 (step S14). The dampers 80a to 80c are controlled based on the carbon dioxide concentrations predicted in step S14 (step S15).

The machine learning device 110 of Modification 1D further uses, as the input information, the biometric information on the people in the target spaces, whereby the carbon dioxide concentrations specific to the target spaces R1 to R3 including the people may be estimated with high accuracy.

With the machine learning device 110, the biometric information includes the conversation amount or the body temperature of the people in the target spaces. Thus, even in a case where the carbon dioxide concentration rises due to an increase in the conversation amount of people in the target spaces R1 to R3, the carbon dioxide concentrations specific to the target spaces R1 to R3 including the people may be estimated with high accuracy.

With the machine learning device 110, the biometric information further includes the gender, age, physique, or posture of the people in the target spaces R1 to R3, whereby the carbon dioxide concentrations specific to the target spaces R1 to R3 including the people may be estimated with high accuracy.

### (6-5) Modification 1E

In the present embodiment, a case where the first acquisition unit 10 acquires the volumes of the target spaces R1 to R3 using a drawing is described, but this is not construed in a limiting sense.

The volume of the target space may also be estimated using the number-of-people information in the target space, the carbon dioxide concentration in the room, the carbon dioxide concentration in the outside air, and the ventilation volume of the ventilating device. For example, when the number of people in the target space is zero, the volume of the target space may be estimated from a reduction in the carbon dioxide concentration in the target space between a certain time point t1 and a time point t2 different from t1.

### (6-6) Modification 1F

The carbon dioxide concentrations in a case where the target spaces R1 to R3 include people may be estimated when the control unit 50 of the ventilation control device 200 controls the ventilating devices 80a to 80c, to perform ventilation control to maintain the carbon dioxide concentrations at a threshold or lower.

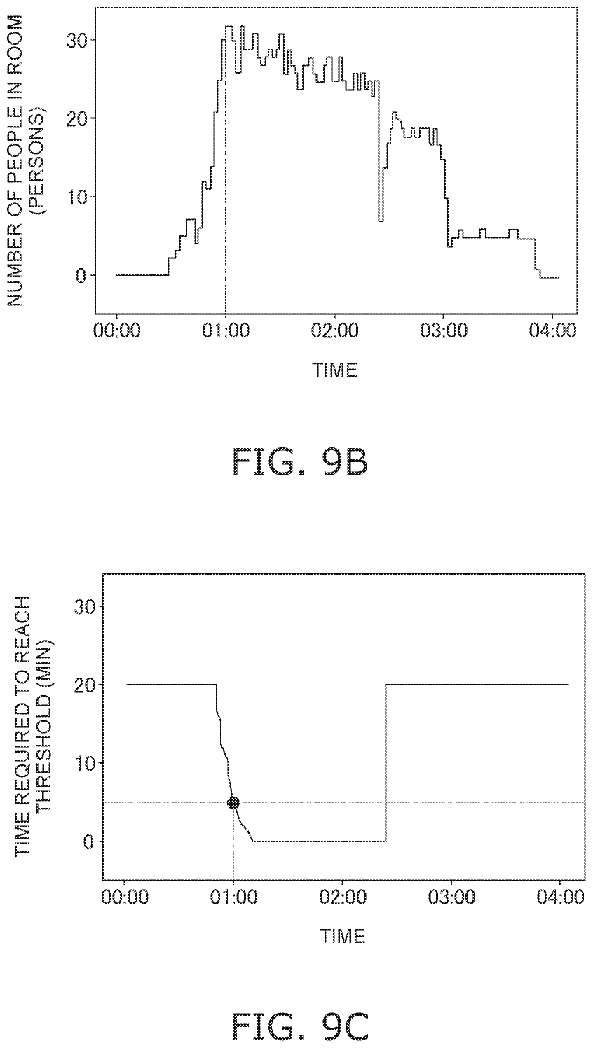

FIG. 9A illustrates an example of a change in the prediction value of the carbon dioxide concentration in the target space R1 over time. FIG. 9B illustrates an example of a change in the number of people in the target space R1 over time. FIG. 9C illustrates an example of a change in the time required for the carbon dioxide concentration in the target space R1 to reach the threshold over time.

The threshold of the carbon dioxide concentration is assumed to be 1000 ppm. When the estimated carbon dioxide concentration in the steady state is equal to or lower than the threshold, the time required for the carbon dioxide concentration to reach the threshold is set to 20 minute. The ventilation control is performed when the time required for the prediction value of the carbon dioxide concentration in the target space R1 to reach the threshold is five minutes or less.

For example, as illustrated in FIG. 9B, the number of people in the target space R1 is 0 at 0:00 and 30 at 1:00.

At 0:00, the actual value of the carbon dioxide concentration in the target space R1 is about 820 ppm. Thereafter, as illustrated in FIG. 9A, the prediction value of the carbon dioxide concentration in the target space R1 is about 958 ppm at 1:00. Thus, the carbon dioxide concentration in the target space R1 is estimated to rise from 0:00 to 1:00. As illustrated in FIG. 9C, the time required for the prediction value of the carbon dioxide concentration in the target space R1 to reach the threshold becomes short between 0:00 and 1:00, and the time required for reaching the threshold is five minutes at 1:00. Thereafter, as illustrated in FIG. 9A, the prediction value of the carbon dioxide concentration in the target space R1 further rises and exceeds the threshold, which is 1000 ppm, until about 2:30. Between 1:00 to about 2:30, as illustrated in FIG. 9C, the time required for the prediction value of the carbon dioxide concentration in the target space R1 to reach the threshold is 5 minutes or less. Therefore, the ventilation control is performed on the target space R1 from 1:00 to about 2:30.

With the carbon dioxide concentration in a case where the target space includes people thus estimated, both safety and energy conservation are achievable by performing ventilation control to maintain the carbon dioxide concentration at the threshold or lower.

Furthermore, a change in the carbon dioxide concentration in the target space may be displayed on a display by using the prediction value of the carbon dioxide concentration in the target space output from the prediction unit 40, which enables a user of the target space to recognize the change in the carbon dioxide concentration. For example, as the change in the carbon dioxide concentration in the target space, the display may display the time required for the prediction value of the carbon dioxide concentration in the target space to reach a predetermined set value. The change in the carbon dioxide concentration in the target space is not limited to a case where the carbon dioxide concentration in the target space rises, and also includes a case where the carbon dioxide concentration in the target space drops.

### (6-7) Modification 1G

In the present embodiment, a case where the learning unit 30 performs machine learning using a supervised neural network to create the carbon dioxide concentration estimation model is described, but this is not construed in a limiting sense. Alternatively, as the machine learning method, linear regression, deep learning, long short term memory (LSTM), or the like may be used.

### Second Embodiment

### (1) Overall Configuration

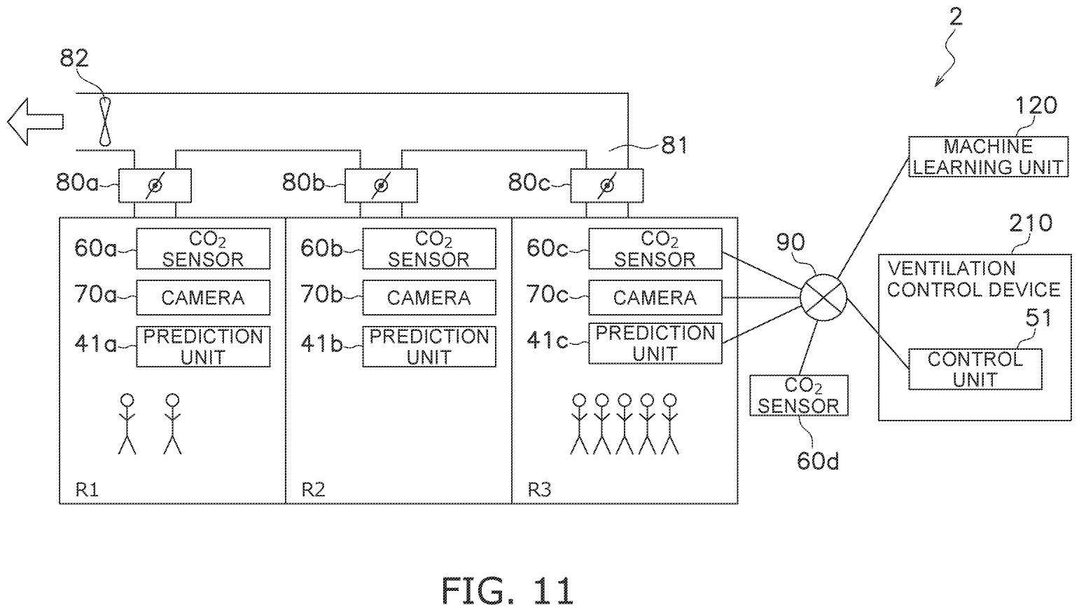

A ventilation control system 2 of the present embodiment is a system provided to perform ventilation control for rooms R1 to R3. As illustrated in FIG. 11, the ventilation control system 2 mainly includes dampers 80a to 80c, a duct pipe 81, a fan 82, carbon-dioxide sensors 60a to 60d, cameras 70a to 70c, prediction units 41a to 41c, a machine learning device 120, and a ventilation control device 210.

The ventilation control device 210 is implemented by a computer. The ventilation control device 200 includes a control unit 51.

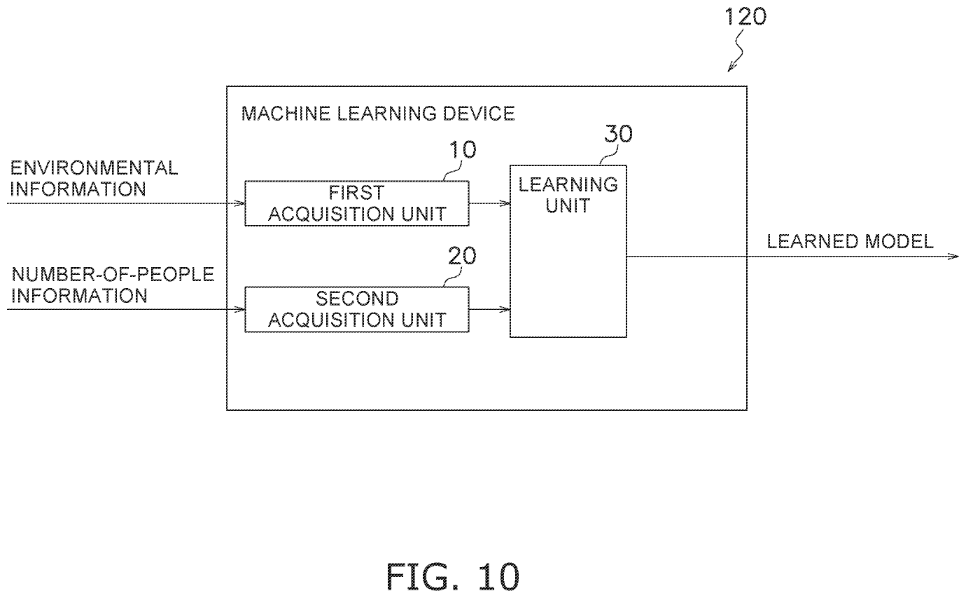

As illustrated in FIG. 10, the machine learning device 120 includes the first acquisition unit 10, the second acquisition unit 20, and the learning unit 30. The first acquisition unit 10 acquires environmental information on the target spaces R1 to R3. The second acquisition unit 20 acquires number-of-people information indicating the numbers of people in the target spaces R1 to R3. The learning unit 30 learns the environmental information and the number-of-people information in association with each other.

The prediction units 41a to 41c are provided in the rooms R1 to R3. The prediction units 41a to 41c include learned models as a result of the learning by the machine learning device 120. The prediction units 41a to 41c predict the carbon dioxide concentrations in the target spaces R1 to R3 after a certain period of time as prediction values from the environmental information and the number-of-people information, based on a result of the learning by the learning unit 30 of the machine learning device 120.

The ventilation control device 210 controls the dampers 80a to 80c, based on the prediction values of the carbon dioxide concentrations in the rooms R1 to R3 after the certain period of time, the prediction values being outputs from the prediction units 41a to 41c.

The machine learning device 120 acquires the actual carbon dioxide concentrations in the rooms R1 to R3 from the carbon dioxide sensors 60a to 60c installed in the rooms R1 to R3, over a network 90. Furthermore, the machine learning device 100 acquires an external carbon dioxide concentration from a carbon dioxide sensor 60d externally installed, over the network 90. Furthermore, the machine learning device 100 acquires the number-of-people information on the rooms R1 to R3 from the cameras 70a to 70c installed in the rooms R1 to R3, over the network 90.

### (2) Detailed Configuration

### (2-1) Machine Learning Device

As illustrated in FIG. 10, the machine learning device 120 includes the first acquisition unit 10, the second acquisition unit 20, and the learning unit 30. Since the configurations of the first acquisition unit 10, the second acquisition unit 20, and the learning unit 30 are the same as those in the first embodiment, a detailed description thereof will be omitted.

### (2-2) Prediction Unit

The prediction unit 41a is installed in the target space R1. The prediction unit 41a predicts, for the target space R1, the carbon dioxide concentration in the target space R1 after a certain period of time as a prediction value from the environmental information and the number-of-people information on the target space R1, based on a result of the learning by the learning unit 30 of the machine learning device 120.

The prediction unit 41b is installed in the target space R2. The prediction unit 41b predicts, for the target space R2, the carbon dioxide concentration in the target space R2 after a certain period of time as a prediction value from the environmental information and the number-of-people information on the target space R2, based on a result of the learning by the learning unit 30 of the machine learning device 120.

The prediction unit 41c is installed in the target space R3. The prediction unit 41c predicts, for the target space R3, the carbon dioxide concentration in the target space R3 after a certain period of time as a prediction value from the environmental information and the number-of-people information on the target space R3, based on a result of the learning by the learning unit 30 of the machine learning device 120.

### (2-3) Control Unit

The control unit 51 controls the damper 80a installed in the target space R1, based on the prediction value of the carbon dioxide concentration in the target space R1 after the certain period of time, the prediction value being an output from the prediction unit 41a. The control unit 51 controls the damper 80b installed in the target space R2, based on the prediction value of the carbon dioxide concentration in the target space R2 after the certain period of time, the prediction value being an output from the prediction unit 41b. The control unit 51 controls the damper 80c installed in the target space R3, based on the prediction value of the carbon dioxide concentration in the target space R3 after the certain period of time, the prediction value being an output from the prediction unit 41c.

The control unit 51 is implemented by a computer. The control unit 51 includes a control calculation device and a storage device (not illustrated). A processor such as a CPU or a GPU is usable for the control calculation device. The control calculation device reads a program stored in the storage device and executes predetermined image processing and calculation processing based on the program. Furthermore, based on the program, the control calculation device may write a calculation result to the storage device and read information stored in the storage device. The storage device is usable for a database.

### (3) Overall Operation

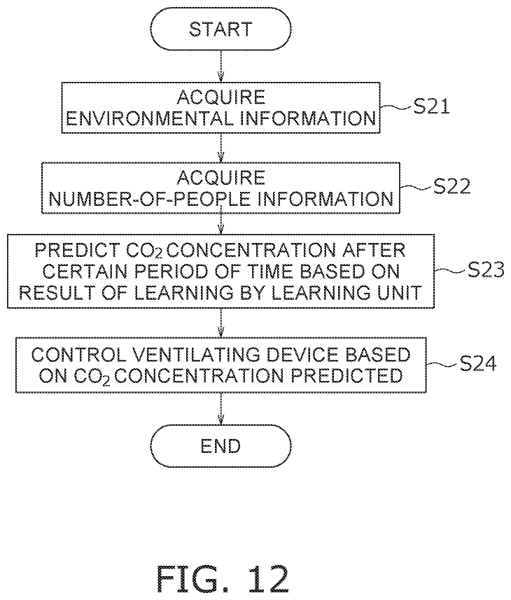

FIG. 12 is a flowchart of the ventilation control system 2. Since the processing is substantially the same as that in the first embodiment illustrated in FIG. 6, a detailed description thereof will be omitted. In the first embodiment, in step S3, the carbon dioxide concentrations after a certain period of time are predicted using the prediction unit 40 of the machine learning device 100. The second embodiment is different from the first embodiment in that, in step S23, the carbon dioxide concentrations are predicted using the prediction units 41a to 41c respectively provided in the target spaces R1 to R3.

### (4) Features

(4-1)

The ventilation control device 210 of the present embodiment includes the first prediction unit 41a, the second prediction unit 41b, the third prediction unit 41c, and the control unit 50. The first prediction unit 41a predicts, for the first target space R1, the carbon dioxide concentration in the first target space R1 after a certain period of time as a prediction value from the environmental information and the number-of-people information, based on a result of the learning by the learning unit 30 of the machine learning device 120. The second prediction unit 41b predicts, for the second target space R2, the carbon dioxide concentration in the second target space R2 after a certain period of time as a prediction value from the environmental information and the number-of-people information, based on a result of the learning by the learning unit 30 of the machine learning device 120. The third prediction unit 41c predicts, for the third target space R3, the carbon dioxide concentration in the third target space R3 after a certain period of time as a prediction value from the environmental information and the number-of-people information, based on a result of the learning by the learning unit 30 of the machine learning device 120. The control unit 51 controls the ventilating device 80a installed in the first target space R1, based on the prediction value of the carbon dioxide concentration in the first target space R1 after the certain period of time, the prediction value being an output from the first prediction unit 41a. The control unit 51 controls the ventilating device 80b installed in the second target space R2, based on the prediction value of the carbon dioxide concentration in the second target space R2 after the certain period of time, the prediction value being an output from the second prediction unit 41b. The control unit 51 controls the ventilating device 80c installed in the third target space R3, based on the prediction value of the carbon dioxide concentration in the third target space R3 after the certain period of time, the prediction value being an output from the third prediction unit 41c.

With the ventilation control device 210, since the target spaces R1 to R3 are provided with the individual prediction units 41a to 41c that predict the carbon dioxide concentrations in the respective target spaces R1 to R3 after the certain period of time, the carbon dioxide concentration in each of the target spaces R1 to R3 after the certain period of time is predicted in advance, so that appropriate ventilation control may be performed on each of the target spaces R1 to R3.

(4-2)

A ventilation control method performed by the ventilation control device 210 of the present embodiment includes a first prediction step, a second prediction step, a third prediction step, and a control step. In the first prediction step, for the first target space R1, the carbon dioxide concentration in the first target space R1 after a certain period of time is predicted as a prediction value from the environmental information and the number-of-people information, based on a result of the learning by the learning unit 30 of the machine learning device 120. In the second prediction step, for the second target space R2, the carbon dioxide concentration in the second target space R2 after a certain period of time is predicted as a prediction value from the environmental information and the number-of-people information, based on a result of the learning by the learning unit 30 of the machine learning device 120. In the third prediction step, for the third target space R3, the carbon dioxide concentration in the third target space R3 after a certain period of time is predicted as a prediction value from the environmental information and the number-of-people information, based on a result of the learning by the learning unit 30 of the machine learning device 120. In the control step, the ventilating device installed in the first target space R1 is controlled based on the prediction value of the carbon dioxide concentration in the first target space R1 after the certain period of time, the prediction value being an output in the first prediction step. In the control step, the ventilating device installed in the second target space R2 is controlled based on the prediction value of the carbon dioxide concentration in the second target space R2 after the certain period of time, the prediction value being an output in the second prediction step. In the control step, the ventilating device installed in the third target space R3 is controlled based on the prediction value of the carbon dioxide concentration in the third target space R3 after the certain period of time, the prediction value being an output in the third prediction step.

With the ventilation control method by the ventilation control device 210, since the target spaces R1 to R3 are provided with the individual prediction steps of predicting the carbon dioxide concentrations in the respective target spaces R1 to R3 after the certain period of time, the carbon dioxide concentration in each of the target spaces R1 to R3 after the certain period of time is predicted in advance, so that appropriate ventilation control may be performed on each of the target spaces R1 to R3.

### (5) Modifications

### (5-1) Modification 2A

In the present embodiment, a case where the three rooms include the first to third prediction units 41a to 41b is described, but this is not construed in a limiting sense. For example, the prediction unit may be provided in each of two or more rooms. Alternatively, the target space may be a single room, and the prediction unit may be provided in one target space.

### (5-2) Modification 2B

While embodiments of the present disclosure have been described above, it should be understood that various changes in mode and detail may be made without departing from the spirit and scope of the present disclosure as set forth in the claims.

1. A machine learning device comprising:
a first acquisition unit configured to acquire environmental information on a target space;
a second acquisition unit configured to acquire number-of-people information indicating a number of people in the target space; and
a learning unit configured to learn the environmental information acquired by the first acquisition unit and the number-of-people information acquired by the second acquisition unit in association with each other,
the environmental information including an actual carbon dioxide concentration in the target space.

2. The machine learning device according to claim 1, further comprising:
a prediction unit configured to predict a carbon dioxide concentration in the target space after a certain period of time as a prediction value from the environmental information and the number-of-people information, based on a result of learning by the learning unit.

3. The machine learning device according to claim 2, wherein
the prediction unit is configured to predict an amount of change in a carbon dioxide concentration in the target space as the prediction value.

4. The machine learning device according to claim 1, wherein
the second acquisition unit is further configured to acquire biometric information on the people in the target space, and
the learning unit is further configured to learn the biometric information acquired by the second acquisition unit in association.

5. The machine learning device according to claim 4, wherein
the biometric information includes a conversation amount or a body temperature of the people in the target space.

6. The machine learning device according to claim 4, wherein
the biometric information includes gender, age, physique, or posture of the people in the target space.

7. The machine learning device according to claim 1, wherein
the environmental information includes a carbon dioxide concentration of outside air, or opening or closing of a door or a window of the target space.

8. The machine learning device according to claim 7, wherein
the environmental information further includes a ventilation volume of the target space or a volume of the target space.

9. A ventilation control device including the machine learning device according to claim 2, the ventilation control device further comprising:
a control unit configured to control a ventilating device installed in the target space, based on the prediction value of the carbon dioxide concentration in the target space after the certain period of time,
the prediction value being an output from the prediction unit of the machine learning device.

10. A ventilation control device including the machine learning device according to claim 1, the ventilation control device further comprising:
a first prediction unit configured to predict a carbon dioxide concentration in a first target space after a certain period of time as a prediction value from the environmental information and the number-of-people information of the first target space, based on a result of learning by the learning unit of the machine learning device;
a second prediction unit configured to predict a carbon dioxide concentration in a second target space after a certain period of time as a prediction value from the environmental information and the number-of-people information of the second target space, based on a result of learning by the learning unit of the machine learning device; and
a control unit configured to control
a ventilating device installed in the first target space, based on the prediction value of the carbon dioxide concentration in the first target space after the certain period of time, the prediction value being an output from the first prediction unit, and
a ventilating device installed in the second target space, based on the prediction value of the carbon dioxide concentration in the second target space after the certain period of time, the prediction value being an output from the second prediction unit.

11. A ventilation control method using the machine learning device according to claim 1, the ventilation control method comprising:
predicting a carbon dioxide concentration in the target space after a certain period of time as a prediction value from the environmental information and the number-of-people information, based on a result of learning by the learning unit of the machine learning device; and
controlling a ventilating device installed in the target space, based on the prediction value of the carbon dioxide concentration in the target space after the certain period of time, the prediction value being an output obtained in the predicting the carbon dioxide concentration in the target space.

12. A ventilation control method using the machine learning device according to claim 1, the ventilation control method comprising:
predicting a carbon dioxide concentration in a first target space after a certain period of time as a prediction value from the environmental information and the number-of-people information of the first target space, based on a result of learning by the learning unit of the machine learning device;
predicting a carbon dioxide concentration in a second target space after a certain period of time as a prediction value from the environmental information and the number-of-people information of the second target space, based on a result of learning by the learning unit of the machine learning device; and
controlling
a ventilating device installed in the first target space, based on the prediction value of the carbon dioxide concentration in the first target space after the certain period of time, the prediction value being an output obtained in the predicting the carbon dioxide concentration in the first target space, and
a ventilating device installed in the second target space, based on the prediction value of the carbon dioxide concentration in the second target space after the certain period of time, the prediction value being an output obtained in the predicting the carbon dioxide concentration in the second target space.

13. The machine learning device according to claim 5, wherein
the biometric information further includes gender, age, physique, or posture of the people in the target space.

14. The machine learning device according to claim 2, wherein
the second acquisition unit is further configured to acquire biometric information on the people in the target space, and
the learning unit is further configured to learn the biometric information acquired by the second acquisition unit in association.

15. The machine learning device according to claim 2, wherein
the environmental information includes a carbon dioxide concentration of outside air, or opening or closing of a door or a window of the target space.

16. The machine learning device according to claim 3, wherein
the second acquisition unit is further configured to acquire biometric information on the people in the target space, and
the learning unit is further configured to learn the biometric information acquired by the second acquisition unit in association.

17. The machine learning device according to claim 3, wherein
the environmental information includes a carbon dioxide concentration of outside air, or opening or closing of a door or a window of the target space.

18. The machine learning device according to claim 4, wherein
the environmental information includes a carbon dioxide concentration of outside air, or opening or closing of a door or a window of the target space.
